(19) United States
(12) Patent Application Publication
(10) Pub. No.: US 2004/0068505 A1
(43) Pub. Date: Apr. 8, 2004

(54) System and method for synchronously editing a file on different client computers

(76) Inventors: Chung-I Lee, Tu-chen (TW); Floye Lin, Shenzhen (CN); David Fan, Shenzhen (CN); Xuechun Lin, Shenzhen (CN); Deyi Xie, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,515

(22) Filed: Dec. 30, 2002

(30) Foreign Application Priority Data
Oct. 4, 2002 (TW) 91122974

(51) Int. Cl. G06F 17/00

(52) U.S. Cl. 707/100

(57) ABSTRACT

A system and method for synchronously editing an electronic file on different client computers. The system includes a database server (1) for storing original files, an application server (2) electrically connected with the database server for accessing and processing data stored in the database server, and a plurality of client computers (4) electrically connected to the application server for downloading files from and uploading files to the database server. The application server includes a directory managing module (20) for managing directories for the original files stored in the database server, a counter managing module (22) for recording times of downloading of files from and uploading of files to the database server, and a file integrating module (24) for integrating original files and corresponding edited files. The system allows users to edit a file simultaneously, and automatically integrates the original file with edited files uploaded by users.

### BACKGROUND OF THE INVENTION

1. Field of the Invention

This invention relates to systems and methods for synchronously editing an electronic file via different client computers, and more particularly, to a system and method which allows different users to edit a file simultaneously and which automatically integrates an original file with edited versions thereof uploaded by the users. This application relates to a contemporaneously filed application titled “SYSTEM AND METHOD FOR SYNCHRONIZING FILES IN MULTIPLE NODES” having the same assignee and partially the same inventors with the invention.

2. Description of Related Art

Nowadays information is routinely transmitted via electronic communications networks for timeliness and convenience. People can easily store and edit received information, and transmit the information to desired persons all in short time. In addition, several users accessing a communications network can share and edit a same file stored in a designated storage device. Network technology greatly facilitates information interchange and considerably improves work efficiency.

Although network technology provides many solutions for information interchange, there are still some shortcomings that effect the timeliness and accuracy of information interchange. In many cases, users cannot edit an electronic file simultaneously. When a file is edited by one user, the file is locked, and any requests for editing by other users are refused. If a file requires editing by a plurality of users, the users can only edit the file one after another. The entire process is unduly time-consuming and inefficient. On the other hand, even when a file can be simultaneously edited by a plurality of users, there may be conflicts among the various versions of the file produced by the users. An important earlier edition may be supplanted by a later edition that is less important.

U.S. Pat. No. 6,212,534, granted on Apr. 3, 2001, discloses a system and method for facilitating collaboration in generating documents among a plurality of networked computer systems. The system of the invention can generate documents according to their structures and contents. However, the system cannot integrate documents edited by different users, and cannot satisfactorily handle conflicting versions of a file produced by the users.

Accordingly, what is needed is a system and method which can overcome the abovementioned problems.

### SUMMARY OF THE INVENTION

A primary object of the present invention is to provide a system which allows different users to edit a file simultaneously and which automatically integrates an original file with edited versions thereof uploaded by the users.

Another object of the present invention is to provide a method which allows different users to edit a file simultaneously and which automatically integrates an original file with edited versions thereof uploaded by the users.

In one aspect of the present invention, a system for synchronously editing a file on different client computers is provided. The system comprises a database server for storing original files, an application server electrically connected with the database server for accessing and processing data stored in the database server, and a plurality of client computers electrically connected to the application server for downloading files from and uploading files to the database server. The application server comprises a directory managing module for managing directories for the original files stored in the database server, a counter managing module for recording times of downloading of files from and uploading of files to the database server, and a file integrating module for integrating original files and corresponding edited files.

In another aspect of the present invention, a method for synchronously editing a file on different client computers is provided. The method comprises the steps of: receiving download requests for an original file from a plurality of client computers; downloading the original file to the client computers from a database server; adding 1 to a value of a counter when implementing each said download operation, an original value of the counter being preset as 0; receiving upload requests for edited files from the client computers, the edited files being edited versions of the original file; uploading the edited files to the database server; subtracting 1 from the value of the counter when implementing each said upload operation; and integrating the original file with the edited files in the database server when the value of the counter is 0.

Other objects, advantages and novel features of the present invention will be drawn from the following detailed description of preferred embodiments of the present invention with attached drawings, in which:

### BRIEF DESCRIPTION OF THE DRAWINGS

FIG. 1 is a schematic diagram of hardware infrastructure of a system for synchronously editing a file on different client computers according to a preferred embodiment of the present invention;

FIG. 2 is a schematic diagram of main function modules of an application server of the system of FIG. 1;

FIG. 3 is a flowchart of a method for said application server to download a file to one client computer in response to a download request sent by the client computer;

FIG. 4 is a flowchart of a method for one client computer to edit a file stored in a database server of the system of FIG. 1;

FIG. 5 is a flowchart of a method for said application server to upload an edited file from one client computer; and

FIG. 6 is a flowchart of a method for said application server to integrate an original file with corresponding edited files uploaded by client computers.

### DETAILED DESCRIPTION OF THE INVENTION

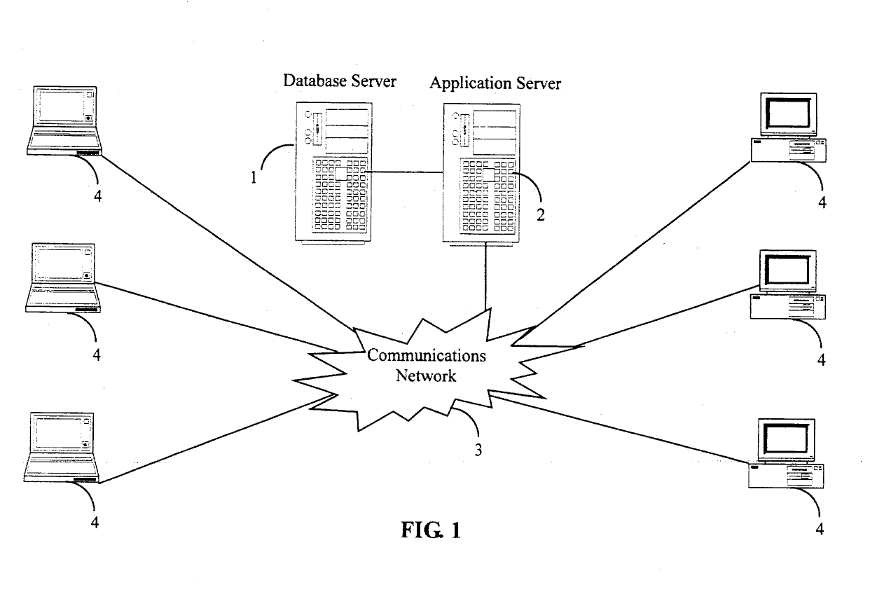

FIG. 1 is a schematic diagram of hardware infrastructure of a system for synchronously editing a file on different client computers according to a preferred embodiment of the present invention. The system comprises a database server 1, an application server 2, and a plurality of client computers 4 that can access the application server 2 via a common communications network 3. The database server 1 is for storing and managing required data. The application server 2 is provided for users to access and edit data stored in the database server 1. The communications network 3 can be an intranet or the Internet. The client computers 4 are at various different locations, and are provided for users to electronically visit the application server 2.

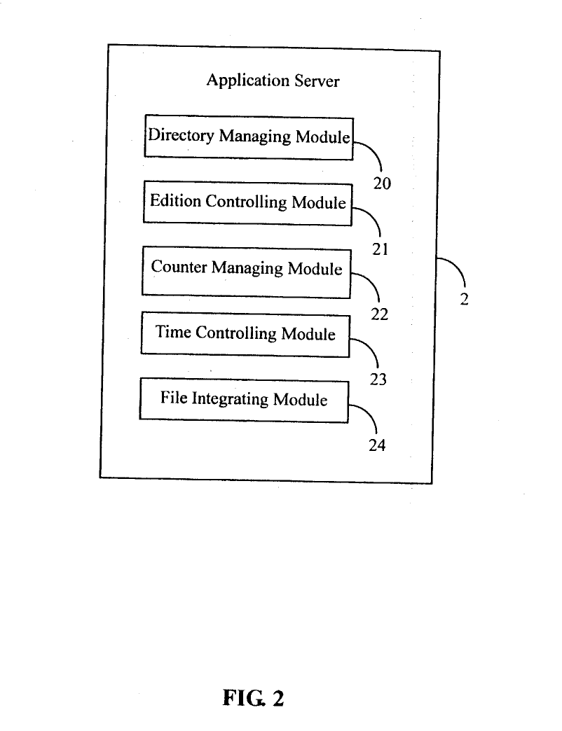

FIG. 2 is a schematic diagram of main function modules of the application server 2. The application server 2 comprises a directory managing module 20, an edition controlling module 21, a counter managing module 22, a time controlling module 23, and a file integrating module 24.

The directory managing module 20 is for setting up and managing directories for all electronic files stored in the database server 1. All data related to each particular electronic file is placed under a designated directory.

The edition controlling module 21 is provided for selecting edition modes to edit required files. There are two edition modes available in the preferred embodiment of the present invention: “primary edition” and “secondary edition.” The “primary edition” mode has the highest priority to edit a file. When there are conflicts between the “primary edition” and the “secondary edition,” the “primary edition” is deemed to prevail. Only authorized users can use the “primary edition” mode to edit a file. Once the “primary edition” mode is selected by a user, other users can only use the “secondary edition” to edit the file.

The counter managing module 22 is for managing a counter located in the application server 2. The counter records current edition states of an electronic file. The original value of the counter is “0.” When a user downloads a file from the database server 1 and begins to edit the file, a value of “1” is automatically added to the counter. After the user finishes his edition and uploads the edited file to the database server 1, a value of “1” is automatically subtracted from the counter. If many users edit a file at the same time, the counter can record whether all users have finished their respective editions. If the value of the counter is “0,” this means that no user is editing the file. Thereafter, the application server 2 can integrate all edited files uploaded by the users and form a new file to replace the original one. If the value of the counter is not “0,” this means that the file is being edited by one or more users.

The time controlling module 23 is for managing durations of editing events. System administrators pre-set a time limit for file editing. Any editing that exceeds the time limit is invalid, and cannot be accepted by the application server 2. When an editing event exceeds the time limit, the time controlling module 23 deems the editing as finished and void, and the value of “1” is automatically subtracted from the counter.

The file integrating module 24 is for integrating files uploaded by users. Edited files of a same original file are uploaded and saved under a designated directory in the database server 1. When the value of the counter is “0,” the file integrating module 24 integrates all the edited files and forms a new file to replace the original one.

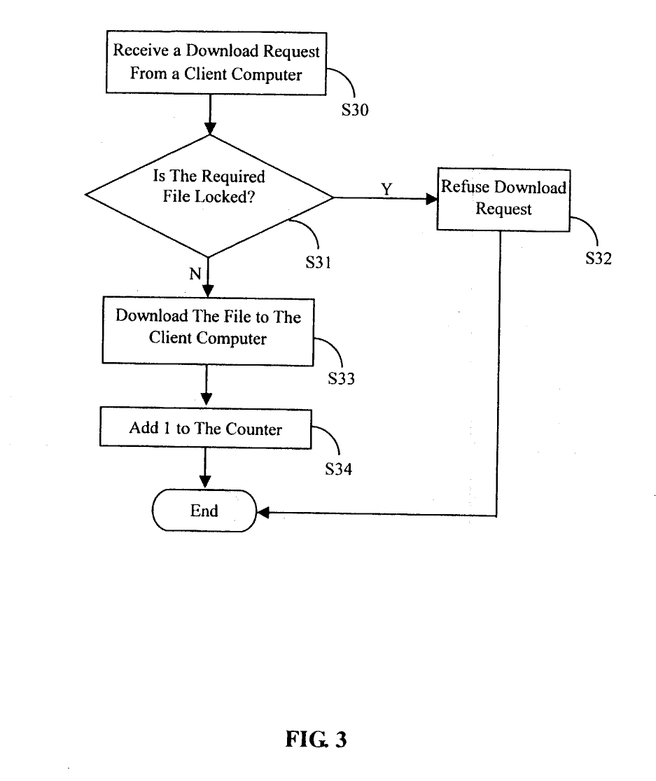

FIG. 3 is a flowchart of a method for the application server 2 to download a file to one client computer 4 in response to a download request sent by the client computer 4. In step S30, the application server 2 receives a download request from one client computer 4. The download request is sent by a user who wants to edit an electronic file stored in the database server 1. In step S31, the application server 2 checks whether the required file is locked. When a file is being edited in the database server 1, the application server 2 locks the file and refuses any operation requests regarding the file sent by the client computers 4. If the required file is locked, in step S32, the application server 2 refuses the download request, and the procedure is ended. If the required file is not locked, in step S33, the application server 2 downloads the required file to the client computer 4. In step S34, the value of “1” is automatically added to the counter.

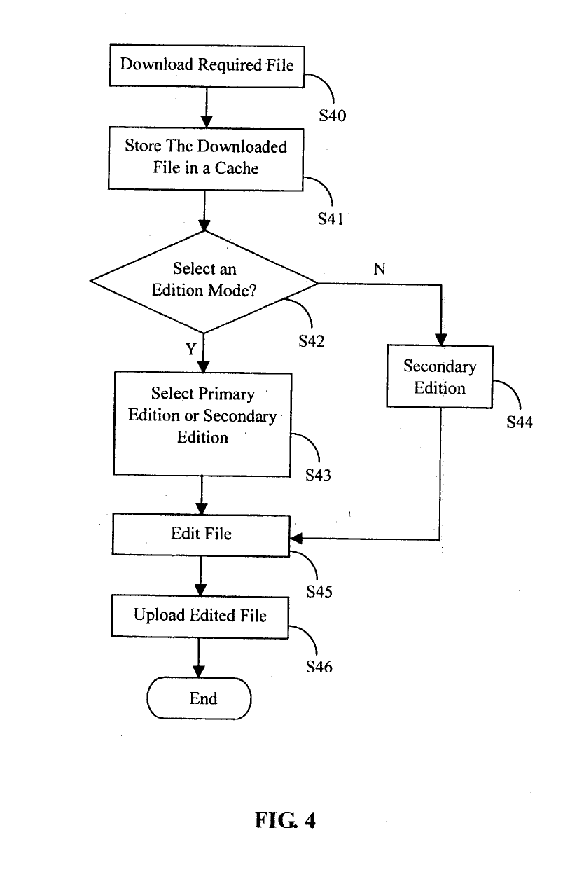

FIG. 4 is a flowchart of a method for one client computer 4 to edit a file stored in the database server 1. In step S40, one client computer 4 downloads a required file from the database server 1 via the application server 2. In step S41, the client computer 4 temporarily stores the file in a cache therein. In step S42, the user of the client computer 4 decides whether or not to select an edition mode. If the user does not select an edition mode, or if the “primary edition” mode has been selected beforehand by another user, in step S44, the application server 2 automatically selects a default edition mode that is preset as “secondary edition,” whereupon the procedure proceeds directly to step S45 described below. If the user decides to select an edition mode, in step S43, the user selects either “primary edition” or “secondary edition.” In step S45, the client computer 4 edits the downloaded file. In step S46, the edited file is uploaded to the application server 2.

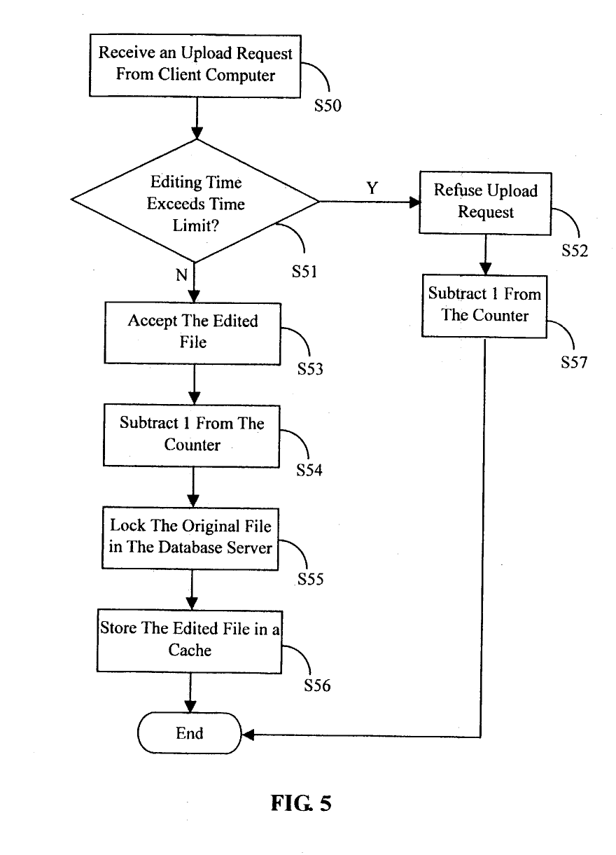

FIG. 5 is a flowchart of a method for the application server 2 to upload an edited file from one client computer 4. In step S50, the application server 2 receives an upload request from one client computer 4 for uploading of an edited file. In step S51, the application server 2 determines whether an editing time of the file exceeds a time limit preset by administrators. That is, the application server 2 records a current time when any client computer 4 downloads and uploads a file. If the time interval between downloading and uploading of the file exceeds the time limit, the application server 2 refuses to accept the edited file. If the editing time of the file exceeds the time limit, in step S52, the application server 2 refuses the upload request from the client computer 4. Thereupon, in step S57, the value of “1” is automatically subtracted from the counter, and the procedure is ended. If the editing time of the file does not exceed the time limit, in step S53, the application server 2 accepts the edited file uploaded by the client computer 4. In step S54, the value of “1” is automatically subtracted from the counter. In step S55, the application server 2 locks the original file in the database server 1. In step S56, the application server 2 stores the edited file in a cache of the application server 2.

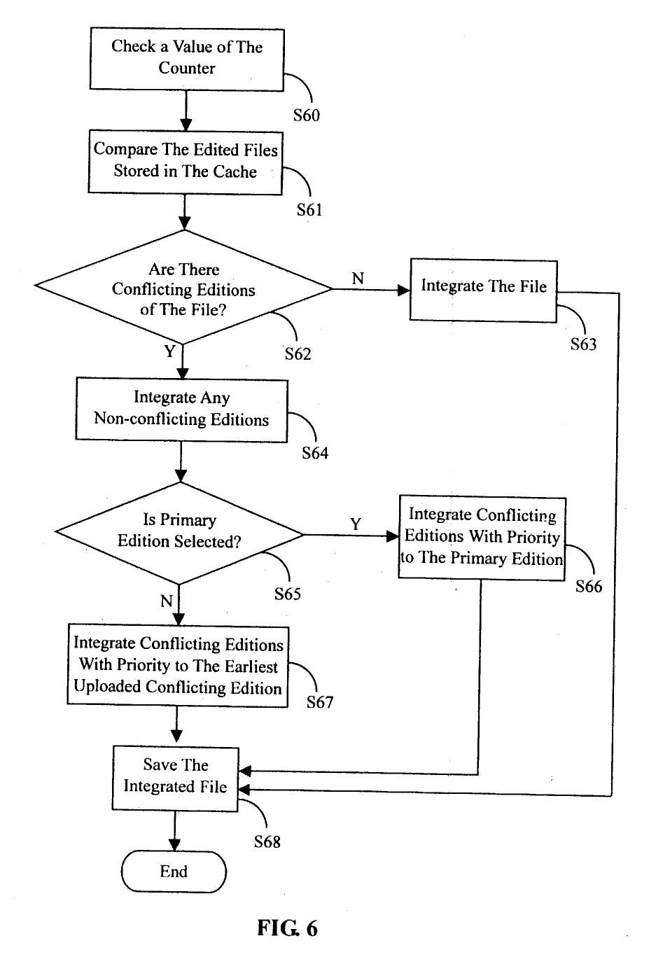

FIG. 6 is a flowchart of a method for the application server 2 to integrate an original file with corresponding edited files uploaded by client computers 4. In step S60, the application server 2 checks a value of the counter. If the value of the counter is “0,” the integration operation can be implemented. In step S61, the application server 2 compares the edited files uploaded by the client computers 4 and stored in the cache of the application server 2. In step S62, the application server 2 determines whether there are conflicting editions of the file. That is, when several client computers 4 edit a same original file, there may be several different editions of a same part of the original file. If there are no conflicting editions of the file, in step S63, the application server 2 integrates the original file and the edited files, whereupon the procedure proceeds directly to step S68 described below. If there are conflicting editions of the file, in step S64, the application server 2 firstly integrates the original file with any edited files that are not conflicting. In step S65, the application server 2 checks whether the primary edition mode is selected. If the primary edition mode is selected, in step S66, the application server 2 integrates the conflicting editions such that the primary edition prevails over all the conflicting editions, whereupon the procedure proceeds directly to step S68 described below. If the primary edition mode is not selected, in step S67, the application server 2 integrates the conflicting editions in priority according to upload times of the conflicting editions. That is, an earliest uploaded conflicting edition is deemed as prevailing over all later uploaded conflicting editions. In step S68, the application server 2 saves the integrated file in the database server 1 by replacing the original file with the integrated file.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for synchronously editing a file through a plurality of client computers, the system comprising:
a database server for storing original files;
an application server electrically connected with the database server for accessing and processing data stored in the database server, the application server comprising a directory managing module for managing directories for the original files stored in the database server, a counter managing module for recording times of downloading of files from and uploading of files to the database server, and a file integrating module for integrating original files and corresponding edited files; and
a plurality of client computers electrically connected to the application server for downloading files from and uploading files to the database server.

2. The system as claimed in claim 1, wherein the application server further comprises an edition controlling module for users to select edition modes to edit original files stored in the database server.

3. The system as claimed in claim 2, wherein the edition modes comprise a primary edition mode and a secondary edition mode.

4. The system as claimed in claim 1, wherein the application server further comprises a time controlling module for managing durations of editing.

5. A method for synchronously editing a file through a plurality of client computers, the method comprising the steps of:
receiving download requests for an original file from a plurality of client computers;
downloading the original file to the client computers from a database server;
adding 1 to a value of a counter when implementing each said download operation, an original value of the counter being preset as 0;
receiving upload requests for edited files from the client computers, the edited files being edited versions of the original file;
uploading the edited files to the database server;
subtracting 1 from the value of the counter when implementing each said upload operation; and
integrating the original file with the edited files in the database server when the value of the counter is 0.

6. The method as claimed in claim 5, further comprising the steps of:
recording a time of each said download operation;
recording a time of each said upload operation;
checking whether a time interval between the time of downloading and the time of uploading for each of the client computers exceeds a preset time limit;
subtracting 1 from the value of the counter for each client computer that has a checked time interval exceeding the preset time limit; and
refusing the upload request sent from each client computer that has a checked time interval exceeding the preset time limit.

7. The method as claimed in claim 5, wherein the step of integrating the original file with the edited files comprises the steps of:
comparing the edited files uploaded from the client computers;
checking whether there are any conflicts between the edited files;
integrating the original file with the edited files when there are no conflicts between the edited files;
checking whether a primary edition mode is selected when there are conflicts between the edited files;
integrating the original file with the edited files with priority to the primary edition when the primary edition mode is selected; and
integrating the original file with the edited files with priority to a time of uploading when the primary edition mode is not selected, with the earliest uploaded file having priority over all other uploaded files.

8. The method as claimed in claim 5, further comprising the step of:
saving the integrated file in the database server by replacing the original file with the integrated file.

9. A method of synchronously editing a same original file on different client computers which are connected to a same database via an application server, comprising:
(1) downloading said same file from the database at said different client computers, respectively;
(2) editing said file at said different client computers, respectively;
(3) uploading said respectively edited files from the client computers to said application server within a preset period;
(4) re-editing said uploading files to be a unified one at said application server; and
(5) uploading said unified file to said database as an updated one for future downloading to said client computers.

10. The method as claimed in claim 9, wherein in step (4), said respective edited files are unified as one according to a default primary editing mode.

11. The method as claimed in claim 10, wherein in steps (4) if no default primary editing mode exists, an editing mode of the first edited uploading file is set as the default/primary editing mode.

12. The method as claimed in claim 9, wherein only portions of the respective edited files without conflicts therebetween from the client computers can be unified and uploaded to the database.
